(19) United States
(12) Patent Application Publication
(10) Pub. No.: US 2013/0331296 A1
(43) Pub. Date: Dec. 12, 2013

(54) Method and System for Combinatorial Electroplating and Characterization

(71) Applicant: Intermolecular, Inc., San Jose, CA (US)

(72) Inventors: Alexander Gorer, Los Gatos, CA (US); Tony Chiang, Campbell, CA (US)

(73) Assignee: Intermolecular, Inc., San Jose, CA (US)

(21) Appl. No.: 13/969,257

(22) Filed: Aug. 16, 2013

Related U.S. Application Data
(63) Continuation of application No. 12/245,547, filed on Oct. 3, 2008.
(60) Provisional application No. 60/977,917, filed on Oct. 5, 2007.

(51) Int. Cl. G01N 27/61

(52) U.S. Cl. CPC G01N 27/61
USPC 506/12

(57) ABSTRACT

The embodiments describe a system for combinatorial processing of a substrate. In one embodiment, electrodeposition processing techniques are combinatorially evaluated. The system is capable of providing a localized electrical connection to each region of a substrate being combinatorially processed. The localized electrical contacts allow for varying a voltage delivered to each region of a substrate whether processing the regions in serial or parallel. Accordingly, from a single substrate, a variety of materials, process conditions, and process sequences may be evaluated for desired electrodeposition results.

### CROSS-REFERENCE TO RELATED APPLICATIONS

This application is a Continuation Application of U.S. application Ser. No. 12/245,547, filed on Oct. 3, 2008, which further claims the benefit of U.S. Application No. 60/977,917 filed Oct. 5, 2007, each of which is incorporated by reference in its entirely for all purposes.

### BACKGROUND

As semiconductor manufacturing processes become more complex, the search for improvements becomes harder to manage. Not only do companies need to develop new materials, but processes and process sequences may also need to be modified along with the materials. In order to manage the evaluation of these variables, an inordinate amount of tests must be performed and data evaluated. Combinatorial processing for the semiconductor manufacturing processes enhances the search for optimized processes and materials.

Electroplating is an electrochemical process by which metal is deposited on a substrate by passing a current through a bath in which the substrate is submerged. Usually there is an anode (positively charged electrode), which is the source of the material to be deposited; the electrolyte, which is the medium through which metal ions are exchanged and transferred to the substrate to be coated, and a cathode which is the substrate (the negatively charged electrode) to be coated. Two electrodes in the electroplating cell (i.e. anode and cathode) are connected to a power supply of direct current (i.e. battery or rectifier). The anode is connected to the positive terminal, and the cathode (future substrate for plating) is connected to the negative terminal. When the external power supply is on, the metal at the anode is oxidized from the zero valence state to form ions with a positive charge (cations). These cations associate with the anions (ions with negative charge) in the solution. The cations are reduced at the cathode to deposit in the metallic state. For example, in an acid solution, copper is oxidized at the anode to Cu²⁺ ions by losing two electrons. The Cu²⁺ ions associates with the anion SO₄²⁻ in the solution to form copper sulfate. At the cathode, the Cu²⁺ ions are reduced to metallic copper by gaining two electrons. The result is the effective transfer of copper from the anode source to a plate covering the cathode. It should be appreciated that the anodes may or may not be sacrificial.

Electrodeposition (e.g., electroplating) of materials is a useful technique for plating films on a surface of a substrate and is utilized in some semiconductor manufacturing operations. For example, electrodeposition of a film may be used in the semiconductor processing operations to deposit a layer of material over a conductive surface of a substrate. There are a number of parameters that may impact the deposition rate and the quality of the film deposited. For example, the seed layer's ability to conduct current for electrodeposition is being challenged due to trends causing an increase in the resistivity of the seed layer. Some of these trends include thinner seed layers, larger diameter wafers, increased pattern density, etc. A thinner seed layer causes current distribution across the wafer to become more non-uniform at a time when the diameter of the wafers is increasing, thus exacerbating the problem. The increased pattern density may also be associated with higher aspect ratios for the features which is driving the need for thinner seed layers to avoid the “necking effect.” As can be seen, these trends may build on each other to pose challenges for electrodeposition processes.

The tests required for optimization of the electrodeposition operations also become numerous and unmanageable, especially when different materials, as well as operating parameters are considered in the testing. As feature sizes continue to shrink, the search for highly conductive copper films is gaining more attention. However, because of the number of parameters and compositions that impact the deposition of any film, the search for improved formulations, materials, and/or processing conditions is slow and inefficient.

It is within this context that the current embodiments arise.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating a system for the electrochemical processing in a combinatorial fashion on a substrate in accordance with one embodiment of the invention.

FIG. 2A is a simplified schematic diagram of a top view of the substrate in accordance with one embodiment of the invention.

FIG. 2B is a simplified schematic diagram illustrating a top view of a substrate which may be used to evaluate electrochemical reactions in accordance with one embodiment of the invention.

FIG. 2C illustrates yet another alternative embodiment of the substrate for use with the electrochemical combinatorial deposition system in accordance with one embodiment of the invention.

FIG. 2D is a simplified schematic diagram illustrating yet another embodiment for providing a voltage to the working electrode in the electrochemical reaction system in accordance with one embodiment of the invention.

FIG. 2E is a simplified schematic diagram illustrating an alternative embodiment to FIG. 2D.

FIG. 3A is a simplified schematic diagram illustrating a flow cell in accordance with one embodiment of the invention.

FIG. 3B illustrates an alternative embodiment to FIG. 3A, where the contact to the wafer is provided through an insert having a plurality of openings substantially aligned the processing regions of the substrate in accordance with one embodiment of the invention.

FIG. 3C is a top view of a simplified schematic diagram of an insert for providing localized voltages to regions of a substrate in accordance with one embodiment of the invention.

FIG. 3D illustrates a cross sectional view of the insert in accordance with one embodiment of the invention.

FIG. 4A is a simplified schematic diagram illustrating an exemplary configuration of a structure defined on a reaction region of the substrate in accordance with one embodiment of the invention.

FIG. 4B is a simplified schematic diagram illustrating the variation of exemplary waveforms for combinatorial application to the substrates during processing in accordance with one embodiment of the invention.

FIG. 5 is a cross sectional view of the region illustrated in FIG. 4A.

FIG. 6 is a simplified schematic diagram illustrating a substrate that has been planarized and is able to undergo accelerated corrosion testing in accordance with one embodiment of the invention.

FIG. 7 is a simplified graph of current (I) versus the voltage (V) for an accelerated corrosion test in accordance with one embodiment of the invention.

FIG. 8 is a flow chart diagram illustrating the method operations for combinatorially evaluating corrosion characteristics of electrode metal in cleaning solutions in accordance with one embodiment of the invention.

FIG. 9 is a simplified schematic diagram illustrating a flowchart diagram for combinatorial electrodeposition and characterization in accordance with one embodiment of the invention.

### DETAILED DESCRIPTION

The embodiments described herein provide a method and system for combinatorial deposition techniques and evaluation of corrosion characteristics for deposited and planarized films. It will be obvious, however, to one skilled in the art, that the present invention may be practiced without some or all of these specific details. In other instances, well known process operations have not been described in detail in order not to unnecessarily obscure the present invention.

The embodiments described herein provide a system and method for performing combinatorial electrodeposition (also referred to as electroplating) that efficiently evaluates a multitude of processes, process parameters, electroplating solutions, etc., in a rapid serial manner and/or a parallel manner on a single substrate. The system includes site isolated wells, also referred to as reaction areas, and individually addressable working electrodes. Even though the working electrodes are individually addressable, the system is flexible so as to allow a single voltage to be applied across the working electrodes. Thus, a single channel potentiostat or a multi-channel potentiostat may be incorporated with the embodiments described below. The tools and techniques enable the ability to electroplate a number of different compositions under varying conditions in a relatively short time. In addition, the properties of the resulting deposited films can be characterized to identify an optimal process sequence and composition. In some instances, the characterization can take place as the plating is occurring or immediately upon completion of the plating in the same or a different tool (e.g., metrology tool). Varied voltages, which may or may not be associated with varied waveforms, may be applied to each of the surfaces within the reaction areas undergoing the electrodeposition.

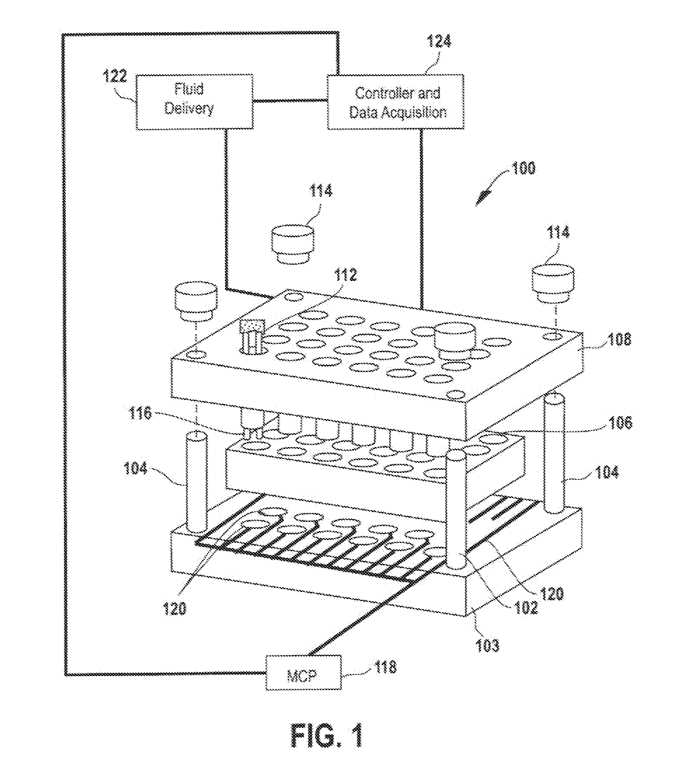

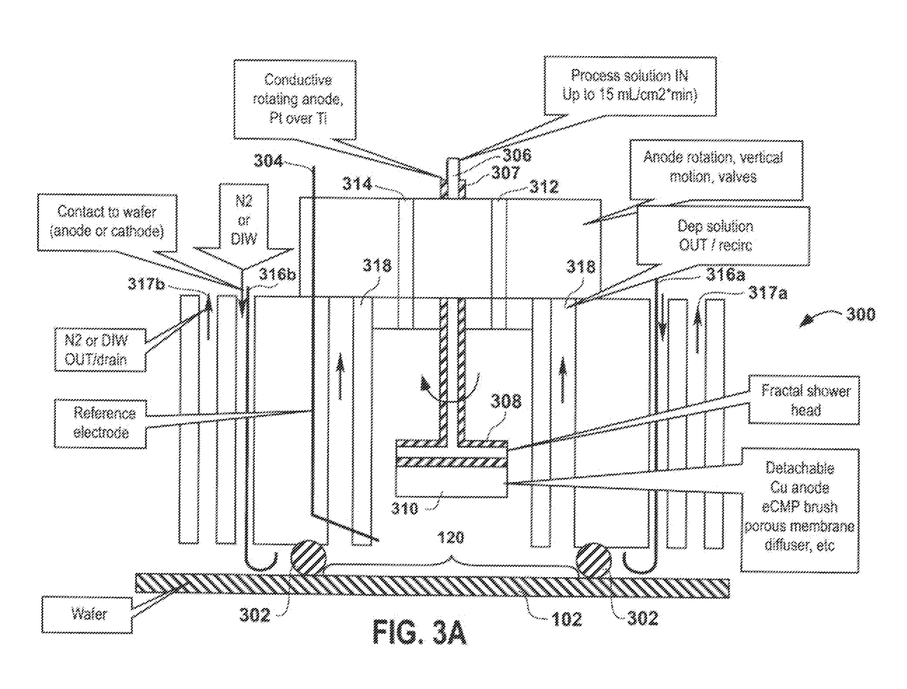

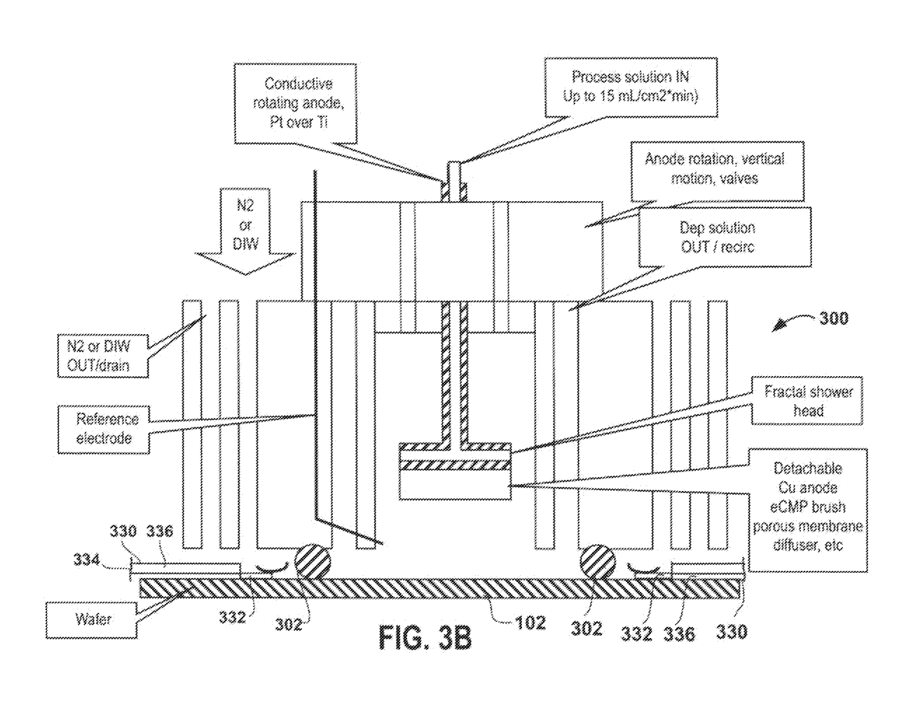

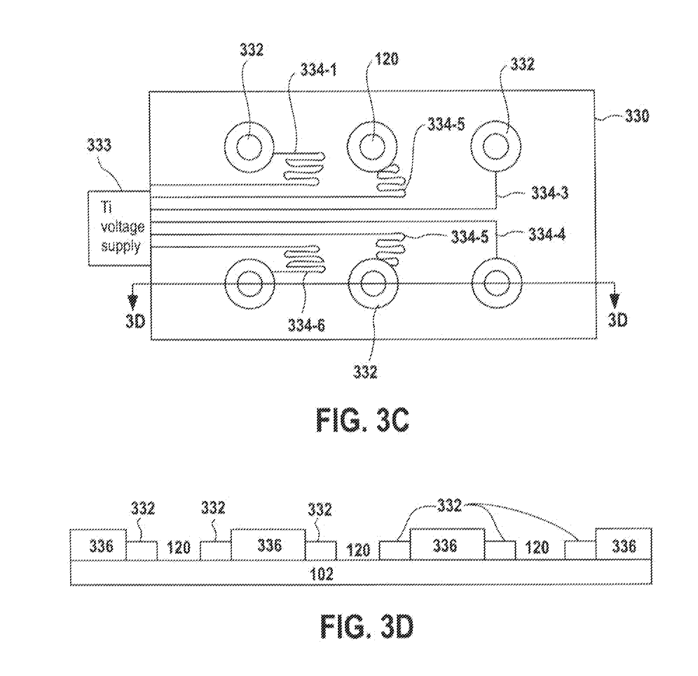

FIG. 1 is a simplified schematic diagram illustrating a system for the electrochemical processing in a combinatorial fashion on a substrate in accordance with one embodiment of the invention. Stage 103 supports substrate 102 to be processed within system 100. Disposed over substrate 102 is reactor block 106. Reactor block 106 includes a plurality of holes extending therethrough, which can be sealed over discrete regions 120 defined on substrate 102. It should be appreciated that substrate 102 may or may not have pre-defined regions disposed thereon. That is, substrate 102 may be a blanket substrate rather than having a plurality of regions disposed on a surface of the substrate. In one embodiment, where substrate 102 is a blanket substrate, the regions can be defined by reactor block 106 or a plurality of flow cells as described in more detail with reference to FIGS. 3A and 3B.

Still referring to FIG. 1, reactor block 106 seals against a top surface of substrate 102. That is, the bottom surface of reactor block 106 will have a seal that is fluid tight as the bottom surface is pressed against a top surface of substrate 120. In one embodiment, inserts or sleeves, as detailed in FIGS. 3A and 3B may be used within the holes defined within reactor block 106 in order to provide the seal. In this embodiment, the inserts or sleeves will provide a seal against a bottom surface of reactor block 106 and a top surface of substrate 102. In one embodiment, top support 108 may provide the force that is translated along the insert or sleeve to provide a seal against the top surface of substrate 102. Top support 108 is disposed over reactor block 106. Top support 108 mates with extensions 104 in order to align the top support with the corresponding reactor block. Knobs 114 are used to secure top support 108 and reactor block 106 over substrate 102, such that the holes of reactor block 106, top support 108 are aligned over substrate 120. In an alternative embodiment, the system of FIG. 1 may include a plurality of the independent flow cells further described in FIGS. 3A and 3B. In addition, while substrate 102 is depicted as rectangular, substrate 102 may be any suitable shape, e.g., circular, and system 100 can be adapted to accommodate numerous other shapes.

Still referring to FIG. 1, electrodes 110 and 112 are provided for the electrodeposition reaction. Electrodes 110 and 112 may be part of an assembly 116 which proceeds through a hole on top support 108 and into a corresponding reaction cell of reaction block 106. In one embodiment, one of electrodes 110 and 112 is a reference electrode, while the other electrode is a counter electrode. It should be appreciated that a reference electrode may be optional as the reference and counter electrode may be combined as a single electrode. One skilled in the art will appreciate that the reference electrode may be a commercially available Ag/AgCl electrode, while the counter electrode may be a platinum mesh or any available conductive material. Assembly 116 may be referred to as a flow cell that provides valving and manifolding for fluid inlets and outlets, agitation, etc, and one embodiment of a flow cell is described further in FIGS. 3A and 3B. Regions 120 defined on substrate 102 are electrically connected to multichannel potentiostat (MCP) 118 in one embodiment. As will be explained in the diagrams below, multiple configurations are available for the working electrode configuration and the electrical connection to MCP 118. Thus, the embodiment of FIG. 1 is not meant to be limiting.

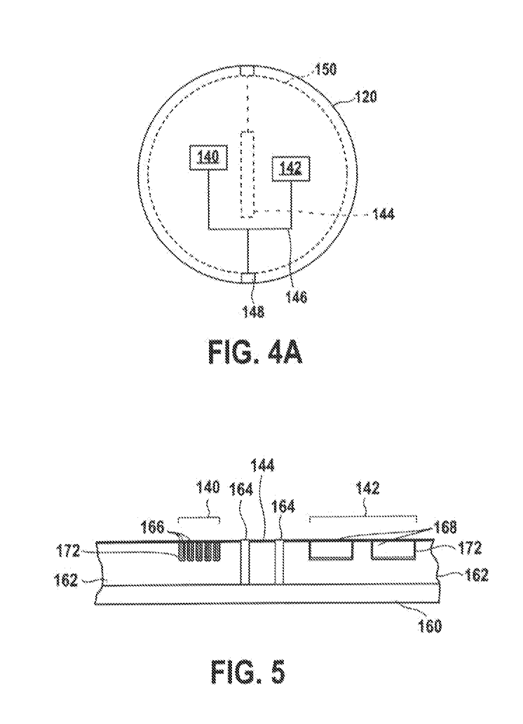

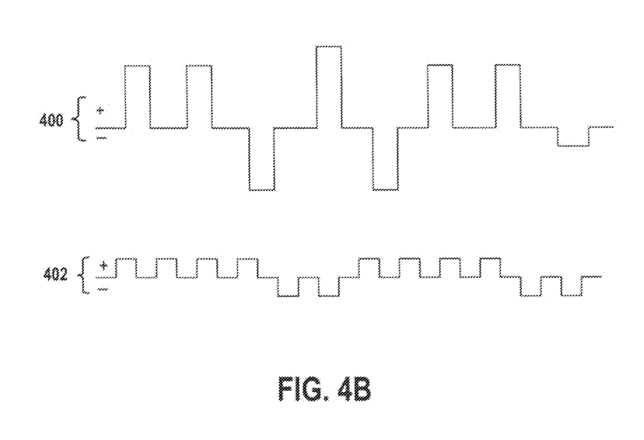

Multichannel potentiostat 118 may be used to provide a locally common voltage or different individual voltages to each of regions 120. In an alternative embodiment, a waveform of the voltages applied to each of the regions may vary, e.g., the amplitude and/or the shape, such as pulse duration or pulse width of the waveform may vary as explained further below. In addition, as discussed in more detail below (see, e.g., FIG. 4A), regions 120 may be provided with numerous structures defined thereon in order to evaluate the plating properties of a multitude of solutions and conditions in a combinatorial fashion. In one embodiment, an insert as described with reference to FIGS. 3B-3D may be utilized to provide localized electrical connections relative to each of regions 120 to further enhance the combinatorial processing capabilities of system 100. One skilled in the art will appreciate that the components of system 100, i.e., top support 108, reactor block 106, assembly 116, and stage 103, are manufactured from material compatible with the operating conditions and chemicals of electrochemical deposition reactions. These materials include synthetic fluoropolymers, such as TEFLON™, Polyetheretherketones (PEEK), and other suitable non-reactive non-particulate generating materials capable of withstanding the various temperatures and environmental conditions, as well as the chemicals, for the electrochemical reactions.

System 100 of FIG. 1 includes fluid delivery system 122 and controller and data acquisition system 124. Controller and data acquisition system 124 functions to provide overall control of fluid delivery system 122 and MCP 118 in one embodiment. In addition, controller and data acquisition system 124 will gather data for analysis and/or characterization of the electrodeposition from each of reaction regions 120. One skilled in the art will appreciate that a computer with appropriate software and hardware can accomplish the specific functionality of controller and data acquisition system 124. Fluid delivery system 122 may include the manifolds, delivery lines, pumps, fluid sources, etc., necessary to provide the fluid, e.g., the electrolyte, to each reaction cell of reactor block 106 in a rapid serial fashion or a parallel manner. Further details on system 100 and alternate systems may be found in co-pending U.S. application Ser. Nos. 11/351,978 and 11/647,881, both of which are incorporated herein by reference for all purposes.

It should be appreciated that the embodiments described herein may be applied to characterize a seed layer or combinatorially evaluate numerous conditions and materials for evaluating the electrodeposition. For example, as will be described in more detail below, a thin seed layer deposited on a blanket substrate can be characterized for the impact of the voltage decrease as a function of distance from a contact in one embodiment. The IR and/or voltage losses from the increased resistance of the seed layer relative to the distance from the power source may be characterized in this embodiment. In another embodiment, the losses relative to the distance may be compensated for through localized contacts provided for regions of the substrate. Thus, different regions may be processed differently in a combinatorial manner with uniform voltage levels within each region due to the localized contacts. Combinatorial processing applied to semiconductor manufacturing operations assists in arriving at a globally optimal sequence of semiconductor manufacturing operations by considering interaction effects between the unit manufacturing operations, the process conditions used to effect such unit manufacturing operations, as well as materials characteristics of components utilized within the unit manufacturing operations. The interaction effects are efficiently evaluated by varying processing parameters over multiple regions of a single substrate. The embodiments described herein provide details for a multi-region processing system and associated reaction chambers that enable processing a substrate in a combinatorial fashion.

Other combinatorial variations include varying any of the processing parameters, electroplating solution chemistry, electrolytes, etc., in combination with or separate from the voltage variations. These variations may be combined with different test structures or substrates. For example, combinatorial electrodeposition of substrates including varying feature sizes, aspect ratios, and densities can be performed. Additionally, substrates including varying predeposited seed layers, which may have various characteristics (e.g., different thicknesses, resistivities, and discontinuities) can also be used with combinatorial processing. The voltage applied to each of the regions may have different waveforms in order to evaluate the uniform deposition over areas of varying density within a region.

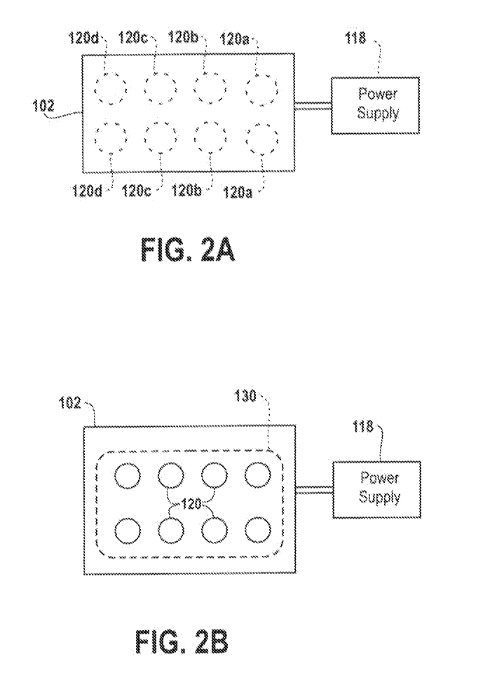

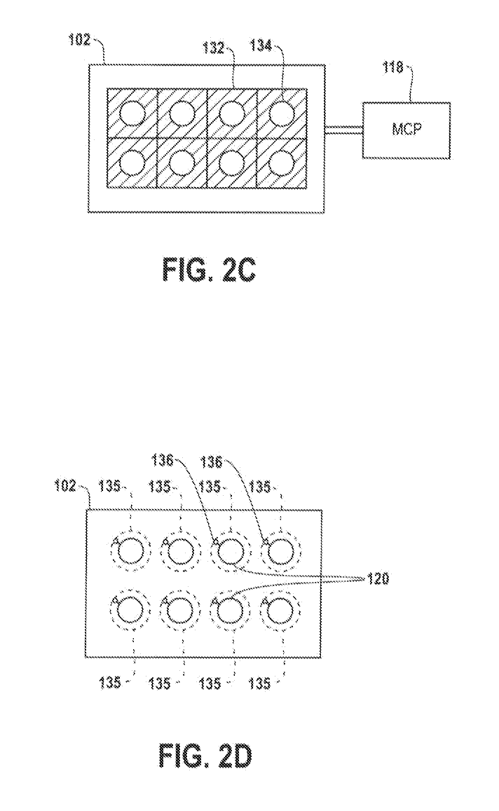

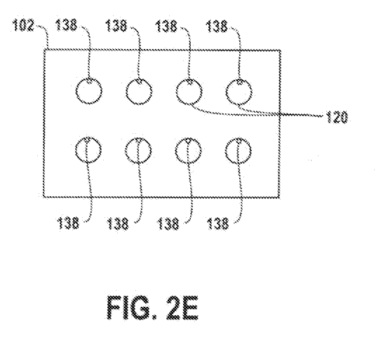

FIG. 2A is a simplified schematic diagram of a top view of the substrate in accordance with one embodiment of the invention. In FIG. 2A, substrate 102 is a blanket substrate. The top surface of substrate 102 may be provided with a blanket copper layer that simulates a copper seed layer of a semiconductor wafer. Power supply 118 provides a voltage to substrate 102 in order to drive the electrochemical reaction. In this embodiment, power supply 118 has a single point of contact with the substrate. It should be appreciated that where substrate 102 from FIG. 2A is inserted into system 100 of FIG. 1, the working electrode, i.e., the copper seed layer, may provide a gradient of voltages along the surface of substrate 102. That is, as the copper seed layer is a relatively thin layer 10-200 Angstroms disposed on substrate 102, the voltage decreases as the distance from the source of the power supply increases due to the relatively high resistivity of the thin seed layer. As noted above, as the thickness of the seed layer decreases to these levels, the resistivity increases even for materials such as copper that tend to have a low resistivity for thicker films. Thus, the voltage experienced by regions near the end opposite from the power supply 118, e.g., regions 120d, is less than the voltage experienced by the regions closest to power supply 118, e.g., regions 120a. In some embodiments, the seed layer can be thicker to provide a more uniform voltage across the substrate.

Accordingly, the voltage is highest at regions 120a and successively decreases through regions 120b, 120c, and 120d, respectively, based on the nature of the copper seed layer. This decrease in voltage can be previously characterized so that the actual voltage supplied in each region is known. Power supply 118 may be a multichannel potentiostat as described above with regard to FIG. 1, however, any multiple parallel power supply may be used in the embodiments described herein. In addition, power supply 118 for FIG. 2A may be a single channel potentiostat in this embodiment as only a single power level is being supplied to the working electrode, but differing voltages are experienced at the reaction regions according to the distance from the power supply.

FIG. 2B is a simplified schematic diagram illustrating a top view of a substrate which may be used to evaluate electrochemical reactions in accordance with one embodiment of the invention. Substrate 102 has disposed thereon a number of regions 120. Reaction regions 120 align with reactor block 106 of FIG. 1 so that electrochemical reactions can occur on the different materials and process conditions that may be defined for each of regions 120. Power supply 118 provides power to substrate 102 through conductive ring trace 130 defined around regions 120 in the conductive film of the substrate. In this manner, the voltage experienced by each of regions 120 will be similar since the distance to the voltage source is similar due to the presence of conductive ring trace 130 and the IR losses are identical for each of the regions 120.

FIG. 2C illustrates yet another alternative embodiment of the substrate for use with the electrochemical combinatorial deposition system in accordance with one embodiment of the invention. In FIG. 2C, substrate 102 has disposed thereon a conductive film 132. Conductive film 132 has a plurality of holes 134 extending therethrough in order to enable access to reaction regions 120, which are located below holes 134. Alternatively, conductive film 132 can be a mesh formed from conductive wire or other conductive material placed in electrical contact with substrate 102. Conductive film 132 may be any conductive film affixed to a top surface of substrate 102 so that the voltage experienced by each of the regions 120 under holes 134 is essentially the same. In essence, conductive film 132 shorts all of the reaction regions to each other to ensure that the voltage supplied to each working electrode of the electrochemical cell is equivalent. In one embodiment, the thickness of conductive film 132 is about 10-100 microns, while the seed layer thickness is about 10-200 Angstroms.

FIG. 2D is a simplified schematic diagram illustrating yet another embodiment for providing a voltage to the working electrode in the electrochemical reaction system in accordance with one embodiment of the invention. Substrate 102 includes reaction regions 120 defined thereon. Proximate to each region 120 is a contact pad 136. In this embodiment, reactor block 106 of FIG. 1 includes a conductive lead or trace in order to provide an electrical connection with contact pad 136. In another embodiment, the flow cell of FIGS. 3A and 3B includes a probe configured to mate with contact pad 136. Thus, through this connection the working electrode for each reaction region 120 may be individually addressed. The lead or probe to each of the contacts 136 may provide a different voltage so that the electrochemical reaction may take place under varying voltage conditions in this embodiment. Regions 136 may be electrically isolated from each other by breaking the continuity of the seed layer disposed over substrate 102 as discussed below.

In one embodiment, a multichannel potentiostat may be connected to each of the individual leads of FIG. 2D to enable different voltages to be supplied to each corresponding region. In this way, combinatorial processing can be performed in a serial, parallel, or serial/parallel manner. For example, a first region may be processed before a second region, a first and second region may be processed at the same time, or a first and second region may be processed at a same time, while a third and fourth region are processed later. In conjunction with a MCP, the different regions can have the waveforms modulated also. That is, the amplitude, pulse width, pulse duration, pulse period, pulse polarity, etc., may all be varied across regions contemporaneously or in series depending on the nature of the combinatorial testing.

Still referring to FIG. 2D, in one embodiment, the conductive film disposed on substrate 102 is etched away from the surface except from the regions defined within contact areas 135. In this embodiment, an etchant supplied to the top surface of substrate 102, while areas 135 are sealed, leaves the conductive film, e.g., the copper seed layer, within regions/areas 135 only. It should be noted that the seal for areas 135 may be separate from or the same as the reactor block used for region 120. For example, area 135 may be sealed and then an etch performed to isolate areas 135 from each other. Area 135 may be sealed in parallel with region 120, e.g., the same flow cell provides seals for each of regions 120 and contact areas 135, or separate from region 120. Furthermore, area 135 may or may not be left in place as an outer ring and additional seal. Thus, each reaction region 120 is isolated electrically from each other. In this embodiment, contact pads 136 are optional, as a probe or a lead pressed against or touching anywhere within contact area 135 and outside of reaction region 120 will provide the necessary voltage to the working electrode. It should be noted that by defining area 135 larger than reaction region 120, alignment issues between the reactor block and the substrate are minimized. As an alternative to etching for defining electrically isolated areas, other techniques may be employed. For example, a scribe may be used to isolate areas 135 by breaking the continuity of the seed layer.

FIG. 2E is a simplified schematic diagram illustrating an alternative embodiment to FIG. 2D. In FIG. 2E, substrate 102 includes regions 120 where contact is made inside the region rather than outside of region 120. In this embodiment, the reactor block may include a probe or lead that extends from the flow cell and makes contact with the bottom surface of substrate 102 at points 138.

FIG. 3A is a simplified schematic diagram illustrating a flow cell in accordance with one embodiment of the invention. Flow cell 300 defines region 120 over substrate 102. O-ring 302 provides a seal to isolate region 120. It should be appreciated that other sealing mechanisms rather than an o-ring may be employed here. These sealing mechanisms include pressure being employed against a pliable member, a knife edge formed on a non-reactive material such as TEFLON, PEEK, etc. Wires 316a and 316b provide the leads for providing localized voltage to region 120. It should be noted that while wires 316a and 316b are illustrated as having a curved bottom end, this is not meant to be limiting. Wires 316a and 316b may be any suitable conductive lead and any suitable shape through which contact is made proximate to region 120 of substrate 102. For example, wires 316a and 316b may be shaped to provide a pressure contact with the region 120. Wires 316a and 316b may be one cylindrical member surrounding an outer diameter of the reactor of flow cell 300 in one embodiment. In one alternative embodiment, a single conductive lead may be used rather than multiple wires 316a and 316b.

In another embodiment, an inert fluid may be supplied or flushed through a cavity along an outer surface of wires 316a and 316b of FIG. 3A, in order to keep the region proximate to the point of contact of wafer 102 and wires 316a and 316b free from any acid developing proximate to the point of contact, due to the environmental moisture and the current flowing through wires 316a and 316b. Outlets 317a and 317b are provided as outlets for any fluid introduced into the cavity along the outer surface of wires 316a and 316b. Flow cell 300, which may be referred to as a reactor, includes inlet 306 through which process solution, e.g., electrolyte solution, may be delivered. Delivery line 306 includes an output to head 308, which can provide the solution to the region defined with the reactor.

Head 308 of FIG. 3A may include several outlets to distribute electrolyte or electrochemical solutions and other fluids onto the region 120. Head 308 may be configured to rotate around an axis of delivery line 306. Head 308 may also be shaped in any shape suitable for mixing the electrolyte solution. For example, head 308 may be shaped to promote laminar flow within the reactor in one embodiment. Head 308 may be a propeller, or any other suitable agitator. Head 308 can have a detachable member affixed thereto for agitation purposes in one embodiment. For example, member 310 may optionally be affixed to head 308. In one embodiment, the agitation may be provided through acoustic energy supplied to the substrate through a resonator. In this embodiment, the vibration from the resonator globally provides agitation to any fluid within the reaction regions. One skilled in the art will appreciate that the acoustic energy may be megasonic energy or ultrasonic energy in one embodiment. It should be further appreciated that the agitation through any of the means described herein assists in refreshing a concentration of the electrolyte at an interface where the deposition is occurring. As the concentration of the active species is depleted through consumption, the stirring, maintains/refreshes the concentration of the active species at a consistent level at the interface of where the deposition is occurring. Member 310 may alternatively be a copper anode (e.g., to perform electroplating relative to the region 120), a brush for utilization with the electrodeposition or electropolishing, a porous membrane, etc. In one embodiment, the membrane is an ion permeable membrane capable of isolating certain components of the solution from the anode or from the cathode.

Still referring to FIG. 3A, flow cell 300 includes vent 312 and alternative inlet 314, which can be included with inlet 306 or optional to inlet 306. In one embodiment, vents 312 and 314 may function as inlets and outlets for air/nitrogen/argon or any other gas to maintain certain ambient conditions above the solution. In another embodiment, vents 312 and 314 are provided for maintaining ambient pressure within the reaction region. In one embodiment, an outer surface of inlet 306 and an outer surface of head 308 are encapsulated with conductive rotating anode 307. Anode 307 rotates along with head 308. Outlet 318 is in flow communication with a vacuum or suction source for removal of fluids from the reactor. Flow cell 300 may include reference electrode 304 in one embodiment. As some non-research applications may not require a reference electrode, the reference electrode 304 is optional. In this embodiment, a potentiostat supplying a current to the combined counter/reference electrode may be adjusted to account for the lack of a reference electrode. One skilled in the art will appreciate that alternative techniques may be utilized for providing a localized voltage. For example, o-ring 302 may be composed of a conductive material. A lead through flow cell 300 having one end connected to a power supply and another end connected to o-ring 302 may provide the localized voltage. In addition, wires 316a and 316b may be configured to contact wafer 102 within region 120, rather than outside region 120 in one embodiment. One skilled in the art will appreciate that anode 307 may actually function as a cathode in some instances depending on the application for which system 100 is being utilized.

FIGS. 3B and 3C illustrate alternative embodiments to FIG. 3A, where the contact to the wafer is provided through an insert 330 having a plurality of openings substantially aligned to the processing regions of the substrate in accordance with one embodiment of the invention. Insert 330 is configured to be disposed in between substrate 102 and reactor block 106 in one embodiment. Insert 330 is composed of an insulative outer coating 336 which includes a plurality of opening configured to substantially align with regions 120. Surrounding each of the openings is a conductive annular member 332, which is in electrical communication with lead 334. Lead 334 provides a voltage from a power supply connected to another end of lead 334. Annular member 332 contacts a top surface of wafer 102 so that the voltage supplied to the annular member may be locally supplied to region 120 of the wafer. It should be appreciated that the embodiment of FIG. 3B eliminated the need for wires 316a and 316b of FIG. 3A.

FIG. 3C is a top view of a simplified schematic diagram of an insert for providing localized voltages to regions of a substrate in accordance with one embodiment of the invention. Insert 330 includes a plurality of openings substantially coinciding with regions 120 of a substrate over which the insert is disposed. In one embodiment, the openings are larger than corresponding region 120 in order to enable the o-ring of the flow cell to seal against the surface of the underlying substrate as illustrated in FIG. 3B. Leads 334-1 through 334-6 provide an electrical pathway between power supply 333 and corresponding annular conductive members 332. In one embodiment, power supply 333 is a MCP. As illustrated, leads 334-1 and 334-6 wind through the insulative portion of the insert so that a length of each of leads 334-1 through 334-6 is substantially equivalent, which in turn would provide for a similar resistance. The equivalent winding of the leads is optional and not meant to be limiting. For example, the leads 334 could be straight or have any other shape.

FIG. 3D illustrates a cross sectional view of the insert in accordance with one embodiment of the invention. Annular members 332 encompass region 120 of wafer 102. As mentioned above, annular members 332 are composed of any conductive material, such as copper, aluminum, gold, silver and their alloys, while insert portions 336 is an insulative material, such as plastic, which includes PTFE and PEEK or other suitable materials commonly used for printed circuit boards.

FIG. 4A is a simplified schematic diagram illustrating an exemplary configuration of a structure defined on a reaction region of the substrate in accordance with one embodiment of the invention. Reaction region 120 includes a first sub region 140 and a second sub region 142. In one embodiment, first sub region 140 includes a number of high aspect ratio features, while second sub region 142 has defined thereon a number of low aspect ratio features. However, each sub region may include high and low aspect ratio features as FIG. 4A is not meant to be limiting. For example, each sub region may include structures with varying feature sizes, aspect ratios, and densities, and may have varying predeposited seed layers, including those with varying thicknesses and resistivities and which may be discontinuous. In this way, multiple experiments can be performed in each region, thereby increasing the number of potential combinatorial variables.

In some embodiments, sub region 142 and 140 are connected through lead 146, which is accessed through contact 148 of FIG. 4A. However, in other embodiments, the seed layer in region 120 may be the lead that provides contact with the sub regions 140 and 142. Contact 148 may be connected to a trace defined on the substrate where one end of the trace is accessible either through a probe as in FIG. 1, or the trace may be individually addressable as mentioned with reference to FIG. 1. Accordingly, through contact 148, a localized voltage may be applied to region 120. Alternatively a global or localized customizable voltage may be applied to region 120 through the embodiments of FIGS. 2A-2E. Consequently, the voltage and/or waveform may be varied locally between the regions or varied globally so that all regions see the same voltage and waveform.

In one embodiment, counter electrode 144 may be embedded into reaction region 120 under the seed layer as illustrated with reference to FIG. 5. In another embodiment, the distance between a surface of counter electrode 144 and surfaces of first and second sub regions 140 and 142 is about half of a diameter of region 120. In yet another embodiment the diameter of counter electrode 144 is approximately equal to the distance between counter electrode 144 and sub region 140 or the distance between counter electrode 144 and sub region 142. One skilled in the art will appreciate that counter electrode 144 may be composed of platinum, however, other suitable known materials for counter electrodes may be substituted, such as copper. Outer periphery 150 may act as a counter electrode in another embodiment. In this embodiment, counter electrode 144 or 150 would have an area that is similar to the combined area of first sub region 140 and second sub region 142, however, this is not meant to be limiting as any area ratio is possible.

FIG. 4B is a simplified schematic diagram illustrating the variation of exemplary waveforms for combinatorial application to the substrates during processing in accordance with one embodiment of the invention. In FIG. 4B two exemplary waveforms are illustrated. In waveform 400, the pulse duration and amplitude are varied. In waveform 402 the pulse duration and amplitudes are kept relatively constant for the waveform. One skilled in the art will appreciate that numerous variations of waveforms are possible. In addition to the square type waveforms illustrated in FIG. 4B, other patterns are possible. For example, saw toothed patterns, sinusoidal patterns, combinations of different patterns, etc., are exemplary waveforms that may be combinatorially tested to determine effects on the plating process.

As mentioned above, different waveforms may be applied to different regions of the substrate or a single waveform may be applied globally to the substrate. In one embodiment, the waveform impacts the deposition rate such that the “positive” pulses encourage plating while the “negative” pulses discourage plating, i.e., provide stripping. With regard to the region illustrated in FIG. 4A, some dense areas may deposit at different rates than less dense areas. Through the manipulation of the pulses, the areas plating the fastest may also be stripped the fastest to eventually result in an even or conformal layer disposed over the different density areas within a reaction region. Consequently, the derived process may be applied to conventional full wafer processing. By combinatorially manipulating the waveforms and the chemistries, a combination that provides for the even deposition over different density areas may be found in an efficient manner. Thus, through the combinatorial application of the waveforms, as well as the combinatorial testing of different chemistries, a wealth of data is obtained from a single substrate. It should be noted that the waveform manipulation may be applied to any of the substrate configurations described herein, e.g., with reference to FIGS. 2A-E, as well as other substrate patterns having isolated regions.

FIG. 5 is a cross sectional view of the region illustrated in FIG. 4A. Layer 160 is a silicon substrate over which reaction region 120 is defined. Layer 162 may be a dielectric disposed over substrate 160. A barrier layer (not shown) may be deposited over the layer 162. Copper seed layer 172 is disposed over dielectric layer 162 (or the barrier layer) and may alternatively connect to the interconnect or transistors in lower levels (not shown) of substrate 160. Copper seed layer 172, as shown, lines the trenches that contain features 166 and 168. Within dielectric layer 162, platinum electrode 144 is disposed. In this embodiment, where platinum electrode 144 is embedded in the reaction region, the platinum electrode is isolated from the rest of the structure by insulators 164. First sub region 140 includes high aspect ratio features 166. Second sub region 142 includes low aspect ratio features 168. In order to evaluate the electrochemical compositions, conditions and sequences efficiently, the multi-aspect ratio features within a region will provide information on the ability of the conditions and compositions to plate both high aspect and low aspect ratio features. It should be noted that the counter electrode may or may not be composed of platinum. In one embodiment, electrode 144 is located a distance from copper seed layer 172 that is a value equal to at least the radius of substrate 160.

It should be appreciated that while different aspect ratio features are provided as examples, in FIG. 5, this is not meant to be limiting. In one embodiment, a feature having a single aspect ratio is provided. Alternatively, no features or more than two sets of features, each with differing aspect ratios may be included. Various types of features, such as conductive lines, trenches, dual damascene features, vias, and holes may be included. In yet another embodiment, different pattern densities may be provided. For example, thick lines spaced apart or a number of vias spaced apart may be defined within the sub regions or contact pads of different sizes and densities may be provided and/or interleaved with the reaction regions. Thus, the different pattern densities may simulate a chip with high density regions, e.g., memory regions, and other less dense regions in one embodiment.

It should be noted that the features may be filled through an electroplating operation utilizing the combinatorial system described herein. Each of regions 120 may be electroplated with varying voltages, temperatures, electrolyte solutions, etc, in order to evaluate the properties of the deposited film. The deposited film may be evaluated through conductance, atomic force microscopy, X-ray fluorescence, total reflection X-ray fluorescence, X-ray reflectivity, diffraction, electron diffraction, X-ray diffraction, X-ray photoelectron spectroscopy, auger electron spectroscopy, optical microscopy, scanning electron microscopy, FTIR/RAMAN spectroscopy, ellipsometry, reflectometry, contact angle, adhesion testing (e.g., stud pull test, MELT, and 4-point bend test), sheet resistance, acoustical spectroscopy, ultrasonic spectroscopy, streaming potential, angle-resolved X-ray photoelectron spectroscopy, atomic emission spectroscopy, and UV photoelectron spectroscopy.

### Characterization Using Corrosion Studies

The embodiments described below refer to a specific aspect of testing or characterization of a deposited layer that has been planarized, or otherwise processed, with reference to corrosion properties in accordance with one embodiment of the invention. While the embodiments described above refer to a deposited layer, it should be appreciated that for the characterization of corrosion properties described in the following embodiments, the deposited layer need not be deposited through an electrodeposition technique. For example, any deposition technique may be used to deposit the referenced planarized layers described below. Of course, one method of depositing the referenced layers is through electrodeposition as described above with reference to FIGS. 1 through 5.

The embodiments discussed below perform accelerated corrosion testing in order to evaluate the properties of a deposited layer to resist future corrosion. It should be noted that the data for the testing may occur during the deposition process or upon completion where additional processing, e.g., planarization, may or may not occur. The testing may be performed on any suitable substrate and is not limited to a substrate having undergone a chemical mechanical planarization operation to planarize a surface of a substrate as is commonly performed in conventional semiconductor manufacturing operations. For example, the substrate may be a blanket substrate with a seed layer disposed thereon. In another embodiment, the substrate may include a seed layer having structures defined thereon. The substrate may also include a combination of regions with and without structures. Accordingly, the exemplary substrate region of FIG. 5 is not meant to be limiting.

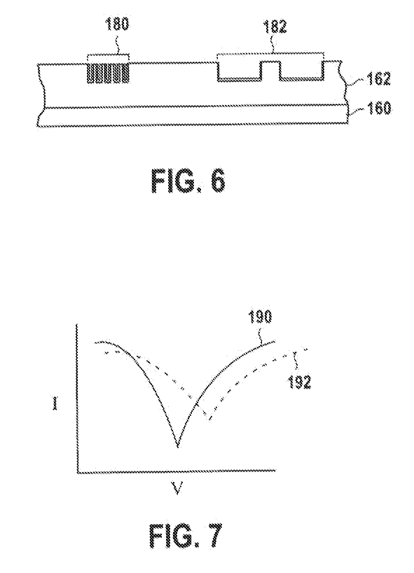

FIG. 6 is a simplified schematic diagram illustrating a substrate that has been planarized and is able to undergo accelerated corrosion testing in accordance with one embodiment of the invention. The substrate of FIG. 6 includes silicon layer 160 over which is deposited interlayer dielectric 162. While regions 180 and 182 are illustrated showing high aspect ratio features filled and planarized in region 180 and low aspect ratio features filled and planarized in region 182, the embodiments are not limited to these features as mentioned above. For example, the testing described herein may occur on a blanket wafer without any features or features having one aspect ratio rather than testing on both aspect ratios. Of course, different pattern densities and geometries also may be used. Thus, it should be appreciated that the exemplary structure of FIG. 6 is not meant to be limiting as the accelerated corrosion properties may be tested on any deposited layer with or without features and the nature of the features do not pose a limit to the accelerated corrosion technique described herein. The substrate of FIG. 6 may have numerous reaction regions which may be tested through a unit similar to the system of FIG. 1. In one embodiment the corrosion characteristics are determined by going from a negative potential to a positive potential relative to the corrosion potential. However, this is not meant to be limiting as the corrosion characteristics may be determined moving from a positive potential to a negative potential relative to the corrosion potential in another embodiment. Furthermore, the material the was deposited is not limited to copper as any conductive material may be evaluated through the described embodiments.

While not specifically illustrated in FIG. 6, it should be noted that a counter electrode may be integrated into the substrate of FIG. 6 as illustrated with reference to FIG. 5. As mentioned above, the substrate of FIG. 6 may be tested for accelerated corrosion characteristics by placing the substrate into a testing system similar to the system of FIG. 1. In this embodiment, the substrate is placed under a reaction block and cleaning solutions would be applied into each of the action cells rather than the electrolyte for the electrochemical deposition described above. One skilled in the art will appreciate that numerous cleaning solutions are available for post cleaning of chemical mechanical planarization (CMP) operations and can be evaluated through the techniques described below. In addition, the embodiments described herein also can evaluate pre-clean steps, such as the pre-clean steps before a deposition operation. In addition to commercially available cleaning solutions, alternative cleaning solutions may be tested through the techniques described herein. It should be noted that after a CMP operation slurry residue or other planarized materials and particulates may exist on a top surface of the substrate. These solutions are cleaned from the substrate surface in a wet processing environment. However, the selection of cleaning solutions must be evaluated in light of any corrosive activity that may occur, which can damage the surface of the substrate being cleaned.

The embodiments described below apply cleaning solutions in a combinatorial fashion and evaluate the result of the cleaning solution in terms of corrosive effects in one embodiment. The cleaning solution may be applied through the fluid delivery system to the plurality of reaction cells in order to perform the parallel testing in a combinatorial fashion. Of course, the testing may be performed in a serial, rapid serial/parallel (i.e., subset of regions run in parallel) or serial/parallel fashion. The embodiments are not limited to CMP post cleaning operations, as the reference to the post CMP cleaning process is for illustrative purposes. Any cleaning process at risk of causing corrosion to a semiconductor device may be evaluated through the techniques described herein. In addition, the embodiments may be extended outside of the semiconductor processing arena, e.g., to the transport of corrosive material, the evaluation of protective coatings, etc.

In one embodiment, a test to determine the effects of corrosion with the particular cleaning solution is a current (I)/voltage(V) test The I/V test will apply a voltage over a time period while the cleaning solution is residing inside the reaction cell on top of the surface of the substrate to be cleaned. At the same time, the current is being measured in order to generate a curve, such as the curve illustrated in FIG. 7. The curve in FIG. 7 is a simplified graph of the logarithm of the absolute value of the current log(abs(I)) versus the voltage (V) (which may also be referred to as a Tafel plot) in accordance with one embodiment of the invention.

In comparing various plots, the point at which the current is lowest will usually indicate a potential optimum cleaning solution relative to the array of cleaning solutions provided through the testing process. Other factors considered may include surface roughness and any impact on other processes. It should be appreciated that the position and the shape of the curve (e.g., left or right relative to other curves) may be determined by environmental condition, e.g., temperature, chemical composition of electrolyte, composition of the surface. In addition, the shape of curve, i.e., the lowest point is an artifact of the log scale and the curves may be linear or other suitable shapes depending on the scales being used. Corrosion normally occurs at a rate determined by an equilibrium between opposing electrochemical reactions. The first reaction is an anodic reaction, in which a metal is oxidized, releasing electrons into the metal. The other is a cathodic reaction, in which a solution species (often O₂ or H+) is reduced, removing electrons from the metal. When these two reactions are in equilibrium, the flow of electrons from each reaction is balanced, and no net electron flow (electrical current) occurs. The two reactions can take place on one metal or on two dissimilar metals (or metal sites) that are electrically connected. The sum of the anodic and cathodic currents are measured in the I/V testing. This current may be measured by sweeping the potential of the metal with the potentiostat in one embodiment. The sharp point in curves 190 and 192 of FIG. 7 is the point where the current changes signs as the reaction changes from anodic to cathodic, or vice versa and is due to the use of a logarithmic axis. This point represents a minimum corrosion point and thus, the lowest point on the curve would identify optimal conditions with respect to corrosion.

In one embodiment, it should be appreciated that the working electrode is the substrate and a voltage may be applied through the working electrode as described above with reference to FIGS. 1 through 5. The counter electrode, whether it is integrated into the surface of the substrate or in the cleaning solution, will function to provide a circuit in which the current is measured. If the counter electrode is defined within a surface of the substrate, then the current may be measured through the wires connecting the counter electrode and working electrode. It should be noted that the reference electrode acts as “sea level” reference point, i.e., the reference electrode provides a common reference across the various regions and process conditions. A reference electrode is an electrode which has a stable and well-known electrode potential, to which other measurements can be compared. Alternatively, the current may be measured in the cleaning solution when the counter electrode is not defined within the substrate surface.

A multi-channel potentiostat may be used to provide the voltage to the array of regions in accordance with one embodiment. The array of regions may be supplied different voltages through the multi-channel potentiostat and the wiring therefrom to the substrate reaction regions, i.e., each region may be individually addressable. As mentioned above, a common voltage may be supplied to each of the reaction regions. Thereafter, the data is captured for analysis and evaluation in order to identify a lowest current point on an I/V curve so that an optimum cleaning solution may be identified. Alternative testing techniques for the corrosion characteristics include optical techniques where the surface of the substrate after exposure to the cleaning solution is optically viewed. For example, a microscope may be used to look at surface color, morphology, structure, etc. In yet another testing technique, surface roughness can be evaluated. Here, atomic force microscopy (AFM) may be used to evaluate the surface roughness. In yet another technique, the conductivity of the reaction region may be evaluated prior to exposure to the cleaning solution and after exposure to the cleaning solution, in order to evaluate the effect of the cleaning solution on the deposited layer.

In one embodiment, the conductivity may be performed through a four point probe in which two probes supply a voltage to contacts on the reaction region and two probes measure current. It should be noted that the evaluation may be performed with the same system that the electrodeposition was performed with, i.e., system 100 of FIG. 1, or a separate system. It should be appreciated that the embodiments described herein provide for combinatorial electrodeposition/electroplating techniques which may or may not be combined with characterization techniques described herein. In addition, the combinatorial electrodeposition/electroplating techniques may be combined with conventional semiconductor processing operations where the entire substrate or majority of the substrate is processed substantially uniform. Thus in a single substrate a plethora of information is available as to the characteristics of the electrodeposited material and any interaction with layers of material deposited thereon.

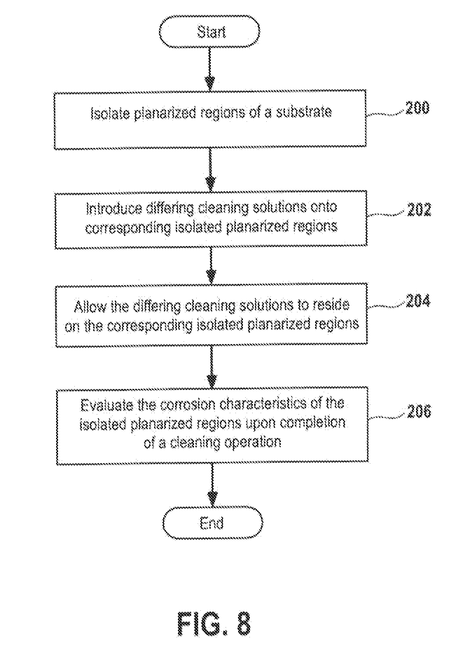

FIG. 8 is a flow chart diagram illustrating the method operations for combinatorially evaluating corrosion characteristics for cleaning solutions in accordance with one embodiment of the invention. The method initiates with operation 200 where the planarized regions of a substrate are isolated. In one embodiment, the system described with reference to FIG. 1 may be used to isolate reaction regions of a planarized surface of a substrate. The method then advances to operation 202 where differing cleaning solutions are introduced onto corresponding isolated planarized regions. In one embodiment, the same cleaning solution can be introduced to the various reaction chambers. The introduction of the cleaning solutions into the reaction chamber may be handled through a fluid delivery system as referred to above.

The method of FIG. 8 then advances to operation 204 where the differing cleaning solutions reside on the corresponding isolated planarized regions for a certain time period. The residence time may be varied for the differing cleaning solutions in one embodiment. It should be appreciated that the cleaning solutions may be removed through the flow cell inserted into the reaction chamber by applying vacuum in order to evacuate the fluid from the reaction chamber in one embodiment. In one embodiment, the I/V curve for the cleaning solutions and corresponding reaction chambers may be measured or monitored while the cleaning solution resides within the reaction chamber. The method then advances to operation 206 where the corrosion characteristics of the isolated planarized regions are evaluated upon completion of the cleaning operation. As mentioned above, the corrosion characteristics may be evaluated through optical techniques, surface roughness characterization, conductivity measurements, and I/V measurements and other suitable characterization tests, which may include rinsing and drying. The operations described above may be performed serially or in parallel. One skilled in the art will appreciate that performing the measurements serially can further provide characterization of the surface time history.

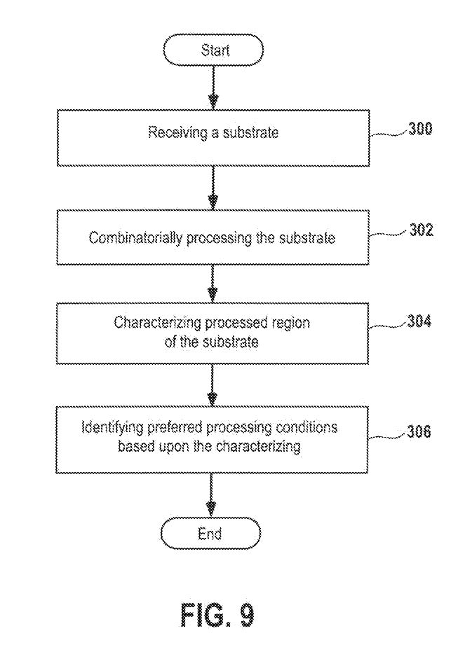

FIG. 9 is a simplified schematic diagram illustrating a flowchart diagram for combinatorial electrodeposition and characterization in accordance with one embodiment of the invention. The method initiates with operation 300 where a substrate is received. The substrate may be a blanket substrate or have predefined regions thereon. The method them advances to operation 302 where the substrate is combinatorially processed where different regions of the substrate are processed differently. As mentioned above, processing parameters, materials, processing sequences and/or unit operations may be varied between the different regions so that different regions are processed differently. In some embodiments, within each region the processing may be substantially uniform. In other embodiments, processing may be varied within a region. Voltages and waveforms applied to the regions may be varied combinatorially. The method then proceeds to operation 304 where the different regions are characterized. Here, the characterization techniques described above may be utilized to evaluate the efficacy of the different processing between the regions. In operation 306 preferred processing combinations are identified based on the characterization. Another combinatorial processing cycle repeating operations 300-306 may be performed utilizing additional variations based on the preferred combinations identified in operation 306. This cycle may be repeated to eventually identify a handful, e.g., ten or less, of promising combinations from a plethora, e.g., thousands or more, of combinations initially.

With regard to the semiconductor industry, an application that the embodiments described herein may assist with is the search for highly conductive copper films deposited through electroplating that are stable in an integrated circuit environment. For example, small features may be difficult to fill, and small features may need to be filled with a higher conductivity material to scale resistance. Characteristics that can be varied with combinatorial electroplating include fill additives, plating conditions, seed layer composition, etc. One goal is to simultaneously fill features and achieve high conductivity. The embodiments described herein evaluate different permutations of the variables in a rapid serial manner or a parallel manner. Of course, the embodiments described below may be applied to numerous other electrodepositions and is not limited to copper films. It should be appreciated that while the embodiments described above reference deposition under controlled voltage conditions, this is not meant to be limiting. For example, the embodiments may be extended to electrodeposition under controlled current conditions and pulse electrodepositions. Furthermore, the different types of depositions, controlled current, controlled voltage, and pulsed may combinatorially evaluated on a single substrate as discussed in the embodiments described herein.

Industries outside of semiconductor manufacturing may benefit from the embodiments described herein. With reference to corrosion control, chemical companies, the petroleum industry, and general infrastructure may take advantage of the embodiments described herein to determine whether materials are compatible with certain processes or environmental parameters.

Additional claims directed towards corrosion control are also provided through the embodiments described herein. In one embodiments method for combinatorially evaluating cleaning solutions is provided. The method includes isolating previously planarized regions of a substrate, introducing differing cleaning solutions onto corresponding isolated planarized regions, and evaluating corrosion characteristics for the differing cleaning solutions of the planarized regions upon completion of a cleaning operation. The evaluation of the corrosion characteristics for the differing cleaning solutions can include applying a voltage to each of the solutions residing on the corresponding isolated planarized regions, measuring a corresponding current associated with the voltage, and identifying an optimal cleaning solution from the differing cleaning solutions based on a relationship between the voltage and the corresponding current. In one embodiment, the voltage is varied over time while the differing cleaning solutions reside on the corresponding isolated planarized regions. As mentioned above, an optimal cleaning solution may be associated with a lowest measured current. The evaluation of the corrosion characteristics for the differing cleaning solutions can include evaluating optical properties of the isolated planarized regions upon completion of the cleaning operation, evaluating roughness characteristics of each cleaned planarized region, and comparing conductivity measurements prior to the cleaning operation and after the cleaning operation for each of the isolated planarized regions. In one embodiment, the optical properties include visible color and visible surface structure, and the roughness characteristics are measured through Atomic Force Microscopy.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for evaluating corrosion, the method comprising:
isolating a plurality of reaction regions on a substrate with a plurality of reaction cells,
applying a solution to a first region of the plurality of reaction regions, and testing for effects of corrosion of the substrate;
wherein process conditions are varied in a combinatorial manner among the plurality of reaction regions.

2. The method of claim 1, wherein the plurality of reaction cells further comprises a plurality of electrodes, and the method further comprises applying a voltage across two electrodes of the plurality of electrodes.

3. The method of claim 2, wherein a first electrode of the plurality of electrodes is a counter electrode integrated into the substrate.

4. The method of claim 2, wherein a first electrode of the plurality of electrodes is a counter electrode disposed in the solution.

5. The method of claim 2, wherein the testing for effects of corrosion comprises measuring a current/voltage relationship during the applying different voltages.

6. The method of claim 2, wherein process conditions are varied by applying different voltages to different reaction regions in parallel through a single contact on the substrate.

7. The method of claim 2, wherein process conditions are varied by varying a waveform of a voltage applied to different reaction regions.

8. The method of claim 1, wherein process conditions are varied by varying a composition of the solution applied to different reaction regions.

9. The method of claim 1, wherein process conditions are varied by varying a residence time of the solution applied to different reaction regions.

10. The method of claim 1, wherein process conditions are varied by varying a temperature of the solution applied to different reaction regions.

11. The method of claim 1, wherein the testing for effects of corrosion comprises microscopic analysis of surface color, morphology, or structure.

12. The method of claim 1, wherein the testing for effects of corrosion comprises measuring surface roughness.

13. The method of claim 1, wherein the testing for effects of corrosion comprises measuring surface conductivity.

14. The method of claim 1, wherein the substrate comprises a semiconductor.

15. The method of claim 1, wherein each of the reaction regions comprises structures having different aspect ratios.

16. The method of claim 1, wherein the testing is performed during an electrochemical deposition process.

17. The method of claim 1, wherein the solution is a cleaning solution.

18. The method of claim 1, wherein the corrosion is accelerated to evaluate the properties of the substrate to resist future corrosion.

19. The method of claim 1, further comprising planarizing one or more layers on the substrate.

20. The method of claim 1, further comprising performing the testing serially to provide a surface time history.
